(19) United States
(12) Patent Application Publication
(10) Pub. No.: US 2026/0365560 A1
(43) Pub. Date: Nov. 19, 2026

(54) TITANIA-SILICA GLASS WITH LOW REFRACTIVE INDEX VARIATION

(71) Applicant: CORNING INCORPORATED, CORNING, NY (US)

(72) Inventors: Michael John Campion, Corning, NY (US); Shihu Wang, Elmira, NY (US); Chunfeng Zhou, Painted Post, NY (US)

(21) Appl. No.: 19/670,474

(22) Filed: May 7, 2026

Related U.S. Application Data
(60) Provisional application No. 63/807,997, filed on May 19, 2025.

(51) Int. Cl. C03C 3/06

(52) U.S. Cl. CPC C03C 3/06; C03C 2201/42

(57) ABSTRACT

A glass body with an SiO₂ concentration of about 80 wt. % or more and a TiO₂ concentration of about 6.0 wt. % to about 12.0 wt. %, and wherein a fast Fourier transform amplitude spectrum of refractive index variation of the glass body satisfies the following equation over a spatial frequency range from 5 m⁻¹ to 3,000 m⁻¹:y≤10^{a}·x^{b}, wherein a is equal to about −3.85 or less and b is equal to about −1.0.

This application claims the benefit of priority to U.S. Provisional Patent Application Ser. No. 63/807,997 filed on May 19, 2025, the content of which is relied upon and incorporated herein by reference in its entirety.

### FIELD

The present disclosure is directed to titania-silica glass body with low refractive index variation. The glass body may be suitable for use in extreme ultraviolet lithography applications.

### BACKGROUND

Extreme ultraviolet (EUV) lithography uses optics to illuminate, project, and reduce pattern images to form integrated circuit patterns. The use of extreme ultraviolet radiation is beneficial in that smaller integrated circuit features can be achieved. The optics for EUV lithography are currently made from low thermal expansion glass, such as silica-titania glass. The glass is traditionally made by a flame hydrolysis process in which high purity precursors are injected into flames to form fine glass particles that are then deposited onto a glass body.

In EUV lithography systems, the glass is typically coated with a reflective surface to form a reflective mirror or a photomask. Furthermore, the glass, in an EUV lithography system, must be able to meet stringent thermal expansion requirements in the system. Specifically, the glass must be able to maintain its surface shape (known as “figure”) when subject to temperature changes in the system. A temperature stable glass is necessary to avoid any induced distortions in the wavefront characteristics of EUV projection optics.

### SUMMARY

Embodiments of the present disclosure comprise methods to produce glass bodies that are able to advantageously maintain their figure during operation of an EUV lithography system. Therefore, the glass bodies, according to the embodiments of the present disclosure, reduce or prevent any distortions in the wavefront characteristics of EUV projection optics. In particular, the glass bodies disclosed herein comprise uniform refractive index with small amounts of refractive index variation throughout.

According to aspects of the present disclosure, a glass body is disclosed that comprises an SiO₂ concentration of about 80 wt. % or more and a TiO₂ concentration of about 6.0 wt. % to about 12.0 wt. %, and wherein a fast Fourier transform amplitude spectrum of refractive index variation of the glass body satisfies the following equation over a spatial frequency range from 5 m⁻¹ to 3,000 m⁻¹:y≤10^{a}·x^{b}, wherein a is equal to about −3.85 or less and b is equal to about −1.0.

According to aspects of the present disclosure, a glass body is disclosed that comprises an SiO₂ concentration of about 80 wt. % or more and a TiO₂ concentration of about 6.0 wt. % to about 12.0 wt. %, and wherein the glass body comprises a maximum fast Fourier transform amplitude of refractive index variation of about .0×10⁻⁶ or less over a spatial frequency range from 30 m⁻¹ to 500 m⁻¹, the glass body comprises a minimum fast Fourier transform amplitude of refractive index variation of about 1.0×10⁻⁹ or greater over a spatial frequency range from 30 m⁻¹ to 500 m⁻¹, the glass body comprises a fast Fourier transform amplitude of refractive index variation of about 2.0×10⁻⁶ or less over a spatial frequency range from 500 m⁻¹ to 3,000 m⁻¹, and the glass body comprises a minimum fast Fourier transform amplitude of refractive index variation of about 0.0×10⁻¹¹ or greater over a spatial frequency range from 500 m⁻¹ to 3,000 m⁻¹.

### BRIEF DESCRIPTION OF THE DRAWINGS

While the specification concludes with claims particularly pointing out and distinctly claiming the subject matter of the description, it is believed that the description will be better understood from the following specification when taken in conjunction with the accompanying drawings.

FIG. 1 is a schematic illustration of a conventional system to produce glass bodies;

FIG. 2 is a flowchart of a process of forming glass bodies, according to embodiments disclosed herein;

FIG. 3A is a schematic illustration of a system to produce loose soot particles in the process of FIG. 2, according to the embodiments disclosed herein;

FIGS. 3B and 3C each show molded bodies according to the process of FIG. 2, according to embodiments disclosed herein;

FIG. 4 shows exemplary glass body produced according to the process of FIG. 2, according to embodiments disclosed herein;

FIG. 5A shows another exemplary glass body with a sub-portion, according to embodiments disclosed herein;

FIG. 5B shows a cross-section of a sub-portion of the glass body of FIG. 5A, according to embodiments disclosed herein;

FIG. 5C shows another cross-section of a sub-portion of the glass body of FIG. 5A with an outer, peripheral lip, according to embodiments disclosed herein;

FIG. 6 shows the refractive index variation of a glass body produced according to the process of FIG. 2, according to the embodiments disclosed herein;

FIG. 7 shows the refractive index variation of a glass body produced using the conventional system of FIG. 1;

FIG. 8 is a plot of the log scale of spatial frequency vs. the fast Fourier transform spectrum of refractive index variation of exemplary and comparative examples;

FIG. 9 is a plot of the log scale of spatial frequency vs. the fast Fourier transform spectrum of refractive index variation of four exemplary examples, according to the embodiments disclosed herein; and

FIG. 10 is another plot of the log scale of spatial frequency vs. the fast Fourier transform spectrum of refractive index variation of four exemplary examples, according to the embodiments disclosed herein.

### DETAILED DISCLOSURE

As used herein, “ppm” means parts per million by weight.

As used herein, “atm” means atmospheric pressure.

As used herein, the term “hydroxyl(s)” or OH means a moiety or a group of moieties each consisting of an oxygen atom and a protium atom (₁¹H, referred to herein as “H”), unless otherwise specified. As used herein, n(OH) means the total number of OH or hydroxyl moieties in a material.

As used herein, “protium” refers to the hydrogen isotope having a mass number of 1 and consisting of a single proton and electron. The symbols “H” and “H2” refer to protium (11H) atoms and molecules, respectively, unless otherwise specified. As used herein, the terms n(H) and n(H₂) refer to the total number of protium atoms and molecules, respectively, in a material.

As used herein, “deuterium” refers to the hydrogen isotope having one proton and one neutron in its nucleus and having an atomic weight of 2.0144. The symbols “D” and “D₂” refer to deuterium (₁²H) atoms and molecules, respectively, unless otherwise specified. As used herein, the terms n(D) and n(D₂) refer to the total number of deuterium atoms and molecules, respectively, in a material.

As used herein, the term “deuteroxyl(s)” or OD means a moiety or a group of moieties, each consisting of an oxygen atom and a deuterium atom (₁²H or ₁²D, referred to herein as “D”). As used herein, n(OD) means the total number of OD moieties in a material. When hydroxyl and deuteroxyl groups are present in their natural isotopic abundance, the ratio of n(OD)/(n(OD)+n(OH)) in the material is equal to 2×10⁻⁴.

As used herein, the terms “hydrogen” and “molecular hydrogen” refer to the naturally occurring mixture of protium and deuterium molecules and atoms (99.98% protium and 0.02% deuterium), unless otherwise stated.

Unless otherwise specified, when reference is made to any element other than hydrogen, it is understood that the element is present in its naturally occurring state; i.e., the isotopic distribution of the element is that which occurs in nature, and the element is not enriched in any one isotope.

As used herein, the term “fictive temperature” refers to a concept used to indicate the structural state of a glass. Glass that is cooled quickly from a high temperature typically exhibits a higher fictive temperature than an identical glass cooled from the same temperature more slowly because of the “frozen in” higher temperature structure. When a glass is held at an elevated temperature, the glass structure is allowed more time to relax toward the heat treatment temperature structure. Glasses with a relatively high fictive temperature have structures that are further removed from equilibrium than glasses with a relatively low fictive temperature.

EUV lithography technology relies on an optical projection system to expose a reflective mirror and/or photomask with EUV light, such that light reflected from the mirror and/or photomask is directed to a thin photosensitive layer deposited on the surface of a semiconductor wafer. This technique is commonly used in the semiconductor device production process. EUV lithography systems operate at a wavelength of light of about 13.5 nm. This extremely short wavelength poses a number of challenges to the design of the EUV systems. For example, reflective coatings on the bodies of the mirror and/or photomask in EUV systems are not able to reflect all of the light with such a low wavelength. About thirty percent of the light is absorbed by the reflective coatings, rather than reflected. The absorbed light produces undesirable heat in the glass body, causing the glass body to change shape (e.g., thermally expand or contract). Such changes in the glass body can in turn cause the reflective coating on the glass body to deform, which leads to distortions in the wavefront of the reflected light. Wavefront distortions may lead to deterioration in the resolution of the EUV system and errors in the patterns formed on the photosensitive layer.

Thus, the glass bodies of the mirror and/or photomask must be able to maintain their shape and figure even when subjected to the demanding thermal loads of EUV systems.

Silica-titania glass, such as ULE® Glass, is presently the material of choice for glass bodies in EUV systems.

It has recently been shown that higher levels of compositional uniformity in silica-titania glass minimize any change of shape of the glass in an EUV system. More specifically, with such higher levels of uniformity, the glass maintains its overall figure when subject to temperature changes in the EUV system. Embodiments of the present disclosure are directed to producing glass bodies with such compositional uniformity. In particular, embodiments of the present disclosure are directed to producing glass bodies with uniform refractive index and uniform concentrations of OH (and OD).

Furthermore, embodiments of the present disclosure are directed to producing glass bodies with either low or high concentrations of OH (and OD). With relatively lower concentrations of OH (and OD), it is easier to produce the desired compositional uniformity in the glass than with relatively higher concentrations of OH (and OD). More specifically, with relatively low concentrations, any offset from a mean OH (or OD) concentration is still within an acceptable range to achieve the required composition uniformity. Because the OH (and OD) concentrations are so low, any offset from the mean OH (or OD) is also quite low. However, with larger concentrations, the offset from the mean concentration can become quite large, thus producing OH (and OD) concentrations that vary widely across the glass body. Because the OH (and OD) concentrations are so high, the offset from the mean can also be quite high.

It is also known in the art that glass bodies with relatively lower OH (and OD) concentrations tend to have higher viscosity, which allows the glass to achieve a higher fictive temperature when annealed. A higher fictive temperature advantageously correlates to a lower coefficient of thermal expansion (CTE) value. As is known in the art, CTE is a material property of the glass that is indicative of the extent to which the material expands (changes shape) when heated. Therefore, lower CTE values advantageously allows the glass body to not change shape when exposed to different temperature environments, which as discussed above, is beneficial in lithography applications.

The compositional uniformity of the glass bodies (e.g., refractive index and OH uniformity) is ultimately desired in order to achieve uniform and low CTE of the glass. Uniform and low CTE values advantageously allow the shape of the glass body to remain substantially constant when the glass is heated, which is necessary in EUV systems. As discussed above, undesirable heat or non-uniform heat in an EUV system can cause a glass body in the system to thermally expand or contract. But a glass body with a uniform and low CTE value would not be as susceptible to such expansion or contraction distortions when heated.

Modifiers may be added to glass bodies to improve the expansivity behavior of the glass. However, it is known in the art that such modifiers decrease the homogeneity of the glass, making it more difficult to create a homogenous glass. A homogenous glass is important not only with regard to the thermal expansion behaviors of the glass but also with regard to its polishing capabilities. For example, the uniformity of the TiO₂ concentration throughout a glass body affects the polishing capabilities of that glass body. In particular, a glass body with different localized areas of TiO₂ concentration would polish unevenly, as areas with different concentrations of TiO₂ in a glass polish at different rates. Therefore, embodiments of the present disclosure also produce glass bodies with uniform concentrations of TiO₂ so that the glass will polish evenly.

Another important feature for glass bodies in EUV systems is the temperature at which the CTE of the glass body is exactly equal to zero. This temperature is known as the zero crossing temperature and is denoted Tzc. Glass bodies in EUV systems should ideally have a Tzc value near the temperature of the glass body when it is exposed to the EUV light of the EUV system. When the Tzc value matches (or is close to) this temperature, the glass body will experience minimal expansion (and, thus, minimal figure distortion) during operation of the EUV system.

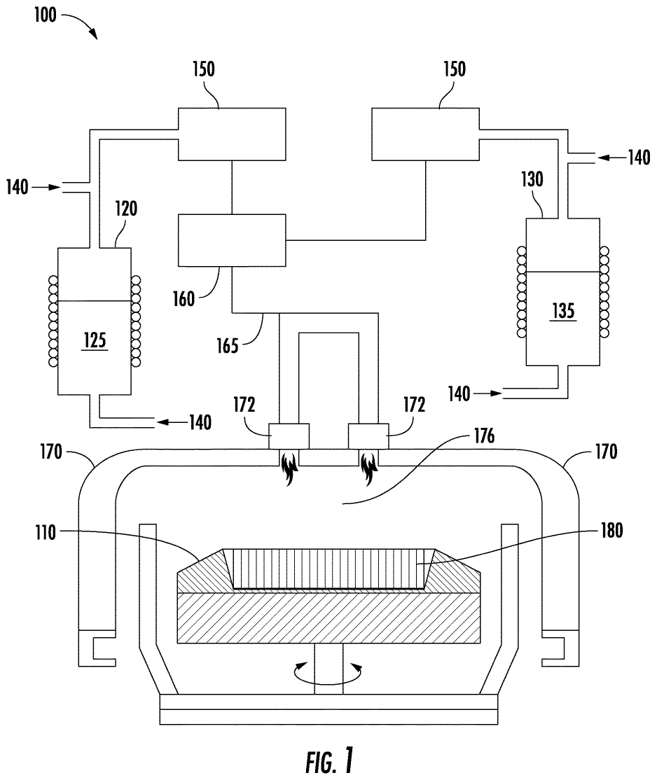

Conventional processes to produce EUV glass bodies are typically referred to as “boule” processes. FIG. 1 shows a conventional system used for such conventional “boule” processes. As shown in FIG. 1, conventional system 100 uses burners to deposit TiO₂—SiO₂ particles into a vessel 110 such that the particles accumulate in a vessel 110. In particular, system 100 includes a silica precursor source 120, which converts silica precursor 125 into vapor form, and a titania precursor source 130, which converts titania precursor 135 into vapor form. A stream of carrier gas 140 is introduced into system 100 to entrain the vapors of the silica precursor 125 through a distribution system 150 and to a mixing manifold 160. Another stream of carrier gas 140 is introduced into system 100 to entrain the titania precursor 135 through a distribution system 155 to mixing manifold 160. The silica precursor 125 and the titania precursor 135 are combined together within mixing manifold 160. This combined mixture then passes through heated fume lines 165 to burners 172 of a furnace 170. As shown in FIG. 1, burners 172 are mounted on a furnace crown 174. Burners 172 are ignited via a fuel and oxygen mixture to react with the silica and titania precursors in the combined mixture, thereby forming titanium-doped silica particles in cavity 176. These particles are directed downward within vessel 110 to form a growing soot body 180. Furnace 170 may be maintained at a consolidation temperature so that the particles are formed from burners 172 and consolidate into glass substantially simultaneously. Vessel 110 may be rotated within furnace 170 as the silica particles are deposited onto growing soot body 180.

However, any variation between burners 172 may result in unequal distribution of the titanium-doped silica particles onto the growing soot body 180. For example, factors such as temperature variations and flame variations can cause the particles distributed from a first burner to be non-uniform with the particles distributed from a second burner. Such may cause, for example, wherein particles on the left side of growing soot body 180 are non-uniform with the particles on the right side of growing soot body 180 (as shown in FIG. 1), thus producing an overall non-uniform soot body.

An object of the present disclosure is to produce a uniform glass body that has small variation in refractive index and composition throughout the glass body.

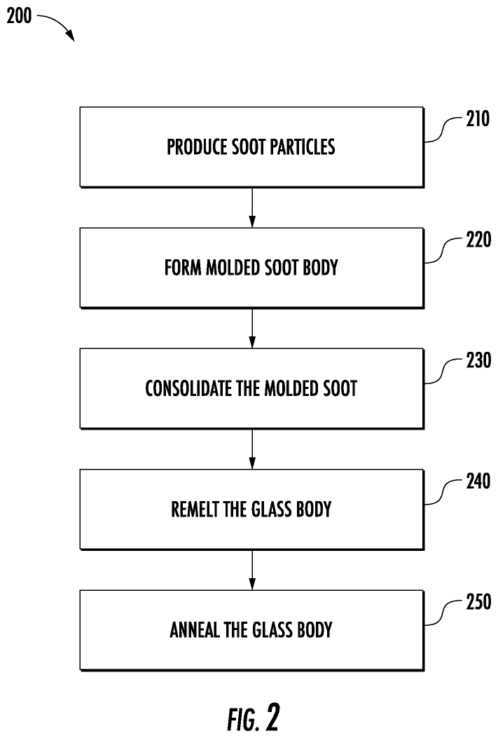

With reference to FIG. 2, a process 200 of producing a glass body according to the embodiments disclosed herein. Step 210 of process 200 comprises the production of soot particles. In the latter steps of process 200, the soot particles are then formed into a molded soot body and consolidated, remelted and/or annealed to form the produced glass body. But, with reference to step 210, the soot particles may be formed as loose soot particles and then collected in one or more chambers.

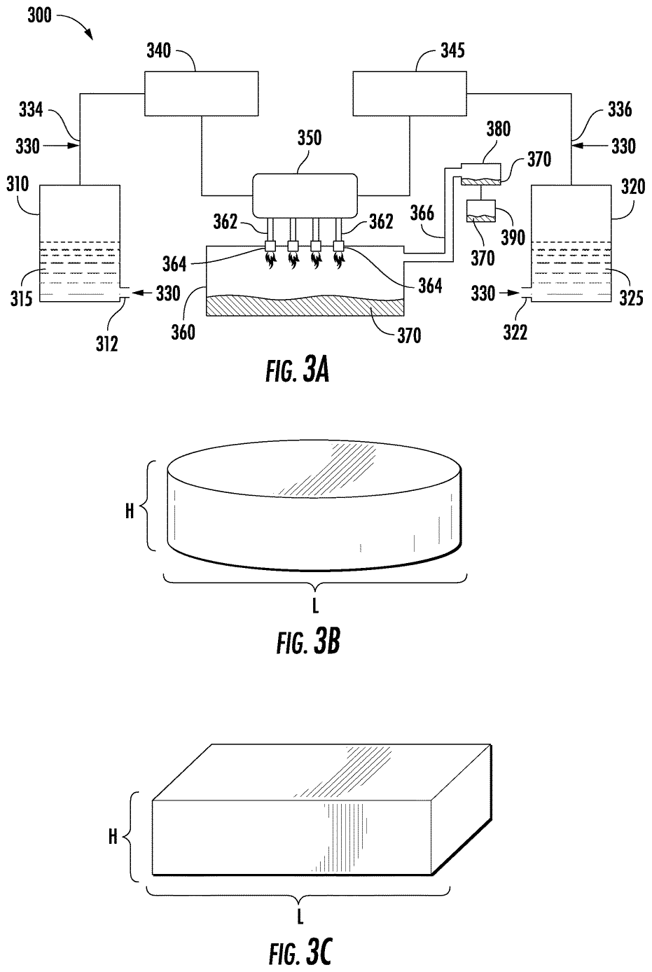

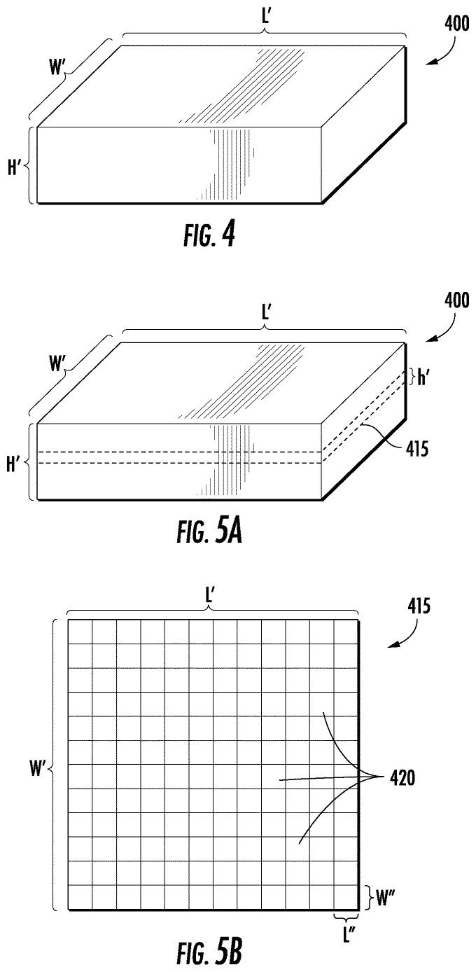

FIG. 3A depicts a schematic representation of a system 300 to produce the loose soot particles of step 210 of process 200 using a combustion process. As shown in FIG. 3A, system 300 comprises a first reservoir 310 that houses a silica precursor 315 and a second reservoir 320 that houses a titania precursor 325. First reservoir 310 includes an inlet 312 for introduction of a carrier gas 330, such as nitrogen, at or near the base of the reservoir. The carrier gas forms a vaporous stream with the silica precursor 315. Similarly, second reservoir 320 includes an inlet 322 for introduction of a carrier gas 330, such as nitrogen, at or near the base of the reservoir. The carrier gas in second reservoir 320 forms a vaporous stream with the titania precursor 325. The silica precursor 315 may comprise, for example, SiCl₄ and/or

octamethylcyclotetrasiloxane (OMCTS). The titania precursor 325 may comprise, for example, TiCl₄ or titanium isopropoxide (TPT) (titanium tetraisopropoxide (TTIP), tetraisopropyltitanate (TIPT)).

Bypass streams of carrier gas 330 are also introduced into system 300 at inlets 334 and 336 to prevent saturation of the vaporous silica stream and the vaporous titania stream. The vaporous silica stream then passes through distribution system 340 to mixing manifold 350, and the vaporous titania stream passes through distribution system 345 to mixing manifold 350.

The silica and titania vaporous streams then mix in mixing manifold 350 to form a mixture of the two streams. As further shown in FIG. 3A, the mixture of the two streams flows to reaction chamber 360. More specifically, the mixture of the two streams passes through fume lines 362 to burners 364 mounted in an upper portion of reaction chamber 360. The two streams are further joined with a fuel/oxygen mixture at burners 364 to combust and oxidize the mixture. The fuel may be natural gas. The oxidation and combustion of the mixture forms loose soot particles 370, which are cooled and directed into reaction chamber 360. Soot particles 370 comprise silicon dioxide and titanium dioxide. More specifically, the silicon dioxide and titanium dioxide in the particles mix at the atomic level to form Si—O—Ti bonds.

In some embodiments, soot particles 370 are directed upward through a tube 366 rather than downward into collection chamber 360. Tube 366 may be a quartz tube, which carries soot particles 370 in a vaporous stream to one or more filter bags 380. The soot particles 370 are removed from the vaporous stream by the filter bags 380 and are then deposited into one or more collection chambers 390. For example, the soot particles 370 fall downward from filter bags 380 and into collection chambers 390. A pulse of N₂ may periodically be applied to filter bags 380 to prevent the excess accumulation of soot particles 370 on the bags. In some embodiments, collection chambers 390 are stainless steel hoppers. The soot particles 370 can then be further collected from collection chambers 390 and deposited into barrels, where soot particles 270 may be stored until further use.

In the embodiments disclosed herein, temperatures of first reservoir 310 and second reservoir 320 are monitored such that the temperature of each are uniform and constant (i.e., +/−0.5 °C) throughout the entirety of each reservoir. Furthermore, a flow rate of the vaporous silica precursor 315 mixed with carrier gas 330 is equal to (or substantially equal to) the flow rate of the vaporous titania precursor 325 mixed with carrier gas 330.

In embodiments, the barometric pressure surrounding system 300 was precisely monitored in order to produce a glass body with the optimal properties disclosed herein (e.g., uniform refractive index and uniform concentration of hydroxyl and titania). Furthermore, it was also found that frequent cleaning of the gas lines within system 300 and frequent replacing of filter bags 380 produce glass bodies with the optimal properties disclosed herein. Soot particles 370 may cool to about 200 °C or less, or about 175 °C or less, or about 150 °C or less, or about 125 °C or less, or about 100 °C or less, or about 75 °C or less, or about 50 °C or less, or about 25 °C or less, or about 20 °C or less before reaching collection chambers 360, 390 in order produce the optical properties disclosed herein in the glass body.

The produced soot particles 370 are spherical in shape with substantially uniform distributions of SiO₂ and TiO₂ within the particles. The size of each soot particle 370 may vary depending on the conditions of burners 364, but in general, soot particles 370 have an average diameter of about 20 nm to about 500 nm, or about 50 nm to about 400 nm, or about 60 nm to about 300 nm, or about 50 nm to about 100 nm.

With reference again to FIG. 2, at step 220 of process 200, soot particles 370 are removed from reaction chamber 360 and/or collection chambers 390 and deposited into a mold to form a pressed and molded soot body. The mold may comprise a pressing apparatus to press the soot particles into the pressed and molded soot body, which has a density of about 0.50 g/cm³ or greater, or about 0.55 g/cm³ or greater, or about 0.60 g/cm³ or greater, or about 0.65 g/cm³ or greater, or about 0.70 g/cm³ or greater, or about 0.75 g/cm³ or greater, or about 0.80 g/cm³ or greater, or about 0.85 g/cm³ or greater, or about 0.90 g/cm³ or greater, or about 0.95 g/cm³ or greater, or about 1.00 g/cm³ or greater, or about 1.05 g/cm³ or greater, or about 1.10 g/cm³ or greater, or about 1.15 g/cm³ or greater, or about 1.20 g/cm³ or greater. Additionally or alternatively, the molded soot body has a density of about 1.50 g/cm³ or less, or about 1.40 g/cm³ or less, or about 1.30 g/cm³ or less, or about 1.20 g/cm³ or less, or about 1.15 g/cm³ or less, or about 1.10 g/cm³ or less, or about 1.00 g/cm³ or less, or about 0.95 g/cm³ or less, or about 0.90 g/cm³ or less, or about 0.85 g/cm³ or less, or about 0.80 g/cm³ or less, or about 0.75 g/cm³ or less, or about 0.70 g/cm³ or less. In embodiments, the molded soot body has a density from about 0.50 g/cm³ to about 1.50 g/cm³, or about 0.60 g/cm³ to about 1.40 g/cm³, or about 0.80 g/cm³ to about 1.30 g/cm³, or about 0.90 g/cm³ to about 1.00 g/cm³, or about 0.80 g/cm³ to about 1.50 g/cm³, or about 0.80 g/cm³ to about 1.20 g/cm³, or about 0.80 g/cm³ to about 0.90 g/cm³. The molded soot body is formed such that any density variation in the body is about 5% or less, or about 4% or less, or about 3% or less, or about 2% or less, or about 1% or less, or about 0.75% or less, or about 0.50% or less, or about 0.25% or less, or about 0.20% or less, or about 0.15% or less, or about 0.10% or less, or about 0.05% or less, or about 0.02% or less, or about 0.01% or less, or about 0.00% from an average density across the body.

In some embodiments, the mold is comprised of graphite and soot particles 370 are pressed uniaxially to form the pressed and molded soot body.

FIG. 3B shows an exemplary cylindrical molded soot body and FIG. 3C shows an exemplary rectangular molded soot body, although the molded soot body may comprise other shapes than those specifically depicted herein. As shown in FIGS. 3B and 3C, the molded soot body has a length L and a height H. It is noted that the length L is also the diameter for the cylindrical body of FIG. 3B.

In embodiments, the length L of the body may be from about 20 mm to about 1300 mm, or about 40 mm to about 1200 mm, or about 60 mm to about 1000 mm, or about 80 mm to about 800 mm, or about 100 mm to about 60 mm, or about 20 mm to about 40 mm. Furthermore, in some embodiments, the height H of the body is about 50 m to about 500 mm, or about 60 mm to about 400 mm, or about 80 mm to about 200 mm, or about 100 mm to about 200 mm, or about 250 mm to about 500 mm, or about 250 mm to about 400 mm, or about 250 mm to about 300 mm, or about 200 mm to about 500 mm, or about 200 mm to about 400 mm, or about 200 mm to about 300 mm. However, it is noted that the length L and height H of the body can vary and are not limited by the embodiments disclosed herein. It is also noted that in some embodiments, the length L is larger than the height H of the body, while in other embodiments the height His larger than the length L.

With reference again to process 200, at step 230, the molded soot body is then consolidated into a glass body, as discussed further below. After consolidation, the body is remelted at step 240 and then annealed at step 250 to relax any internal stress in the body and lower the Tf in the body, along with lowering Tf variations in the body. Relaxed internal stress allows for better quality cutting and machining of the body, such as slicing the body into a plurality of slices. In some embodiments, the body is annealed for a duration of about 100 hours or more, or about 200 hours or more, or about 250 hours or more. The maximum annealing temperature may be from about 750 °C to about 1200 °C, or about 800 °C to about 1100 °C, or about 900 °C to about 1000 °C. Once the annealing step is complete, the body may be subjected to subsequent finishing steps such as shaping, grinding, polishing, and/or slicing.

During the consolidation of step 230, the molded soot body is heated in a furnace. In some embodiments, the molded soot body is first heated to a first temperature T1 between about 800 °C and about 1100 °C, or about 825 °C and about 1075 °C, or about 850 °C and about 1050 °C, or about 875 °C and about 1025 °C, or about 900 °C and about 1000 °C, or about 925 °C and about 975 °C, or about 950 °C and about 1000 °C. The body may be held at the first temperature T1 such that the first temperature T1 is constant during the entirety of the first thermal treatment, with any temperature varying only by about 5 °C or less, or about 4 °C or less, or about 3 °C or less, or about 2 °C or less, or about 1 °C or less, or about 0.5 °C or less from an average temperature during the first thermal treatment. Due to such constant temperature, the heating of the body at the first temperature T1 may also be referred to as an isothermal hold.

In embodiments, the first time duration during which the molded soot body is heated to the first temperature T1 is from about 30 minutes to about 35 hours, or about 1 hour to about 30 hours, or about 1.5 hours to about 27 hours, or about 2 hours to about 25 hours, or about 4 hours to about 22 hours, or about 6 hours to about 20 hours, or about 8 hours to about 18 hours, or about 10 hours to about 15 hours, or about 12 hours to about 16 hours, or about 30 minutes to about 10 hours, or about 1 hour to about 8 hours, or about 15 hours to about 30 hours. In some exemplary embodiments, these time durations are for a body with a length L of 0.25 m and a height H of 0.25 m.

Heating of the body at the first temperature T1 may be in an inert environment in the presence of an inert gas. By “inert gas,” it is meant a gas that does not chemically react with the body. In some embodiments, as discussed further below, the body may be exposed to a steam doping process while heating the body at the first temperature T1.

While not wishing to be bound by theory, it is believed that heating the body at the first temperature T1, as disclosed herein, advantageously produces uniform pressure and temperature in the body by enabling purging and removal of gases from the body, which ultimately helps to achieve the refractive index uniformity disclosed below.

The consolidation of step 230 of process 200 further comprises a ramp-up step during which the temperature increases from the first temperature T1 to a second temperature T2. The increase in temperature from first temperature T1 to second temperature T2, during the ramp-up step, may be at a rate of about 20 °C/hour or greater, or about 25 °C/hour or greater, or about 30 °C/hour or greater, or about 35 °C/hour or greater, or about 40 °C/hour or greater, or about 45 °C/hour or greater, or about 50 °C/hour or greater, or about 55 °C/hour or greater, or about 60 °C/hour or greater, or about 65 °C/hour or greater, or about 70 °C/hour or greater, or about 75 °C/hour or greater, or about 80 °C/hour or greater. In some embodiments, the increase in temperature from first temperature T1 to second temperature T2, during the ramp-up step, may be at a rate from about 20 °C/hour to about 120 °C/hour, or about 30 °C/hour to about 100 °C/hour, or about 40 °C/hour to about 80 °C/hour, or about 50 °C/hour to about 100 °C/hour, or about 50 °C/hour to about 80 °C/hour. A total time duration of the ramp-up step may be from about 0.5 hours to 18 hours, or about 1 hour to about 16 hours, or about 1.5 hours to about 14 hours, or about 2 hours to about 12 hours, or about 2.5 hours to about 12 hours, or about 3 hours to about 10 hours, or about 4.5 hours to about 8 hours, or about 5 hours to about 6 hours.

The consolidation of step 230 of process 200 further comprises heating the molded soot body at the second temperature T2, which is between about 1050 °C and about 1250 °C, or about 1100 °C and about 1200 °C, or about 1125 °C and about 1200 °C, or about 1150 °C and about 1200 °C, or about 1100 °C and about 1150 °C, or about 1125 °C and about 1175 °C, or about 1125 °C and 1150 °C. The body may be held at the second temperature T2 such that the second temperature T2 is constant during the entirety of the second thermal treatment, with any temperature varying only by about 5 °C or less, or about 4 °C or less, or about 3 °C or less, or about 2 °C or less, or about 1 °C or less, or about 0.5 °C or less from an average temperature during the second thermal treatment. Due to such constant temperature, the heating of the body at the second temperature T2 may also be referred to as an isothermal hold.

The body may be held at the second temperature T2 for a second time duration t2 of about 6 hours or greater, or about 10 hours or greater, or about 1 day or greater, or about 2 days or greater, or about 3 days or greater, or about 4 days or greater, or about 5 days or greater, or about 6 days or greater, or about 7 days or greater, or about 8 days or greater, or about 9 days or greater, or about 10 days or greater. In some embodiments, the maximum time duration may be about 20 days or less, or about 18 days or less, or about 16 days or less, or about 14 days or less, or about 12 days or less, or about 10 days or less, or about 8 days or less, or about 6 days or less, or about 4 days or less, or about 2 days or less, or about 1 day or less.

While not wishing to be bound by theory, it is believed that the majority of the glass sintering to fully consolidate the body is performed during the heating of the body at the second temperature T2.

The consolidation process steps disclosed herein (e.g., the heating of the glass body at the first temperature T1, the heating of the glass body at the second temperature T2, and/or the ramp-up step) may be conducted under vacuum pressure wherein the body is not actively doped with hydroxyl. These embodiments may be referred to as “no OH doping” because the thermal treatment steps and/or ramp-up step are conducted in an atmosphere that is free (or essentially free) of water and steam. In contrast, in other embodiments, the consolidation process steps disclosed herein (e.g., the heating of the glass body at the first temperature T1, the heating of the glass body at the second temperature T2, and/or the ramp-up step) may be conducted in the presence of steam, which is also referred to herein as steam doping. As discussed further below, the body is doped with hydroxyl during the steam doping such that the resultant glass body has a relatively higher concentration of hydroxyl. Conversely, the “no OH doping” process produces a glass body with a relatively lower concentration of hydroxyl.

In yet other embodiments, the body may be actively dried during the consolidation process steps disclosed herein (e.g., the heating of the glass body at the first temperature T1, the heating of the glass body at the second temperature T2, and/or the ramp-up step). During such active drying embodiments, the body is exposed to a drying agent while heating the body. In embodiments, the drying agent may be a halide, such as chloring and/or fluorine, or carbon monoxide. Actively drying the body during the consolidation steps produces a glass body with a reduced concentration of hydroxyl, even less when compared with the “no OH doping” process.

It is further noted that in the “no OH doping” and steam doping processes, the body may not be exposed to a halide agent. Therefore, in these embodiments, the final glass body may not comprise a halide such that the produced glass body is halide-free (may comprise less than 100 ppm of a halide or even 0.00 ppm of a halide).

As discussed above, the body may be exposed to a steam doping process during the consolidation process steps disclosed herein (e.g., the heating of the glass body at the first temperature T1, the heating of the glass body at the second temperature T2, and/or the ramp-up step) so that the body is consolidated in the presence of steam. Such increases the hydroxyl concentration in the resultant glass body. The steam doping process comprises exposing the body to a steam-containing atmosphere within the consolidation furnace to load the body with hydroxyl groups. The steam-containing atmosphere may include only steam or steam in combination with an inert gas. The partial pressure of the steam may be about 1.0 atm or less, or about 0.50 atm or less, or about 0.40 atm or less, or about 0.30 atm or less, or about 0.20 atm or less, or about 0.10 atm or less, or about 0.05 atm or less. In embodiments, the partial pressure of the steam is greater than about 0.00 atm, or about 0.01 atm or greater, or about 0.05 atm or greater, or about 0.08 atm or greater, or about 1.0 atm or higher, or greater than about 0.00 atm to about 1.0 atm, or about 0.05 atm to about 1.0 atm, or about 0.25 atm to about 0.8 atm, or about 0.50 atm to about 0.75 atm, or greater than about 0.00 atm to about 0.25 atm, or greater than about 0.00 atm to about 0.20 atm. It is noted that in embodiments in which the body is exposed to the “no OH doping” process (as opposed to the steam doping process), the partial pressure of steam within the consolidation furnace is at 0.0 atm (it is noted that 0.0 atm may only be achieved in theory while, in practice, a partial pressure of about 0.02 atm or less may be achieved for the “no OH doping” process due to practical limitations). During the steam doping process, the steam partial pressure should be constant within the consolidation furnace with any pressure difference being only +/−2% of the absolute pressure in the furnace. It is also noted that longer steam doping exposure times lead to higher concentrations of hydroxyl in the body.

In some embodiments, the body is exposed to an environment comprised of steam during the heating of the glass body at the first temperature T1, the heating of the glass body at the second temperature T2, and the ramp-up step. In other embodiments, the body is exposed to an environment comprised of steam during the heating of the glass body at the second temperature T2 (but not during the heating of the glass body at the first temperature T1 and not during the ramp-up step).

The use of steam in the above-disclosed steam doping processes offers many benefits including the benefit of high hydroxyl concentrations in the glass, which reduces viscosity, promotes low fictive temperature, and avoids seed formation in the glass.

Additional embodiments of the above-disclosed steam doping process are disclosed in U.S. Pat. No. 9,580,350, which is incorporated by reference in its entirety.

With the completion of the consolidation of step 230, the molded body is now converted to consolidated glass, which is then remelted (step 240) and annealed (step 250), in the embodiments disclosed herein.

After the completion of the consolidation of step 230, in some embodiments, the consolidated glass body may be exposed to an environment with an elevated pressure and an elevated temperature, which may be referred to as “hot isostatic pressing.” In particular, the consolidated glass body may be exposed to a temperature from about 30 atm to about 1050 atm, or about 50 atm to about 800 atm, or about 100 atm to about 600 atm, or about 200 atm to about 400 atm, or any range or combination of ranges encompassing these endpoints. Furthermore, the elevated temperature may be in a range from about 1000 °C to about 1800 °C, or about 1100 °C to about 1700 °C, or about 1200 °C to about 1600 °C, or about 1300 °C to about 1500 °C, or about 1400 °C to about 1500 °C, or any range or combination of ranges encompassing these endpoints. The consolidated glass body may be subject to the environment with the elevated pressure and the elevated temperature for a duration of about 120 hours or less, or from about 1 hour to about 120 hours, or about 2 hours to about 100 hours, or about 5 hours to about 80 hours, or about 10 hours to about 60 hours, or about 20 hours to about 40 hour, or any range or combination of ranges encompassing these endpoints. Without being bound by theory, it is believed that the elevated temperature and elevated pressure causes gas inclusions within the glass body to collapse, thus further contributing the uniformity of the produced glass bodies.

After the annealing of step 250 of process 200, a glass body is produced. FIG. 4 shows an exemplary glass body 400 produced using the processes disclosed herein. Glass body 400 may be an ingot or a substrate to which one or more layers may be applied in downstream processing. Furthermore, glass body 40 may be a sliced or un-sliced body. And glass body 400 may be flat, substantially flat, concave, or convex in structure. As discussed further below, glass body 400 may comprise various properties and compositional features.

As shown in FIG. 4 shows an exemplary glass body 400 has a length L′, a width W′, and a height H′. In some embodiments, each of the length L′ and the width W′ may be greater than the height H′. For example, the length L′ and the width W′ may each be about 2000 mm or less, or about 1700 mm or less, or about 1500 mm or less, or about 1200 mm or less, or about 1000 mm or less, or 700 mm or less, or about 500 mm or less, or about 450 mm or less, or about 400 mm or less, or about 350 mm or less, or about 300 mm or less, or about 250 mm or less, or about 200 mm or less, or about 150 mm or less, or about 100 mm or less, or about 75 mm or less, or about 50 mm or less, or about 25 mm or less, or about 20 mm or less, or about 15 mm or less. Additionally or alternatively the length and width of glass body 10 are each about 15 mm or greater, or about 20 mm or greater, or about 25 mm or greater, or about 50 mm or greater, or about 75 mm or greater, or about 100 mm or greater, or about 150 mm or greater, or about 200 mm or greater, or about 250 mm or greater, or about 300 mm or greater, or about 350 mm or greater, or about 400 mm or greater, or about 450 mm or greater, or about 500 mm or greater, or about 700 mm or greater, or about 1000 mm or greater, or about 1200 mm or greater, or about 1500 mm or greater, or about 1700 mm or greater, or about 2000 mm or greater. In some embodiments, both the length L′ and the width W′ are about 150 mm, or about 152 mm, or about 179 mm, or about 530 mm, or about 1200 mm. However, it is also contemplated that the length L′ can be different from the width W′ in some embodiments.

Furthermore, the height H′ may be smaller than each of the length L′ and the width W′. In some embodiments, the height H′ is about 400 mm or less, or about 350 mm or less, or about 300 mm or less, or about 250 mm or less, or about 200 mm or less, or about 150 mm or less, or about 100 mm or less, or about 75 mm or less, or about 50 mm or less, or about 25 mm or less, or about 20 mm or less, or about 15 mm or less, or about 10 mm or less, or about 5 mm or less. Additionally or alternatively, the height H′ is about 5 mm or greater, or about 10 mm or greater, or about 15 mm or greater, or about 20 mm or greater, or about 25 mm or greater, or about 50 mm or greater, or about 75 mm or greater, or about 100 mm or greater, or about 150 mm or greater, or about 200 mm or greater, or about 250 mm or greater, or about 300 mm or greater, or about 350 mm or greater, or about 400 mm or greater. In some embodiments, the height is about 63 mm, or about 150 mm, or about 152 mm.

In embodiments, glass body 400 has a mass of 2.0 kg or greater, or about 2.5 kg, or greater, or about 5 kg or greater, or about 15 kg or greater, or about 20 kg or greater, or about 30 kg or greater, or about 50 kg or greater, or about 100 kg or greater, or about 150 kg or greater, or about 200 kg or greater or about 300 kg or greater, or about 400 kg or greater, or about 500 kg or greater.

Glass body 400 may have a silicon dioxide (SiO₂) concentration of about 80 wt. % or more, or about 85 wt. % or more, or about 90 wt. % or more, or about 92 wt. % or more, or about 95 wt. % or more, or about 97 wt. % or more, or about 98 wt. % or more, or about 99 wt. % or more, or from about 85 wt. % to about 97 wt. %, or from about 90 wt. % to about 95 wt. %.

As also shown in FIG. 5A, glass body 400 comprises at least one sub-portion, such as sample 415, having a length and a width equal to the length and width of body 400, respectively. However, the height h′ of sample 415 may be less than the height H′ of body 10. In some embodiments, the height h′ of sample 415 is about 200 mm or less, or about 150 mm or less, or about 100 mm or less, or about 75 mm or less, or about 50 mm or less, or about 25 mm or less, or about 20 mm or less, or about 15 mm or less, or about 10 mm or less, or about 5 mm or less. In some embodiments, the height h′ is about 7.62 mm. It is also contemplated, in some embodiments, that the height h′ of sample 15 may be equal to the height H′ of body 10.

In the embodiment of FIG. 5A, glass body 400 comprises multiple samples 415 along its height H′. However, it is also contemplated in other embodiments, that one sample 415 extends for the entire height H′ of body glass 400. In these embodiments, glass body H′ only comprises one sample 415 such that the one sample 415 forms the entire glass body 400.

Although FIG. 5A depicts glass body 400 and sample 415 as being square components with flat surfaces, it is also contemplated in embodiments that glass body 400 and/or sample 415 comprise other shapes. For example, the outer profile of glass body 400 and/or sample 415 can be circular or elliptical or a non-symmetrical shape. Furthermore, glass body 400 and/or sample 415 can be curved forming a concave or convex structure. Sample 415 may be a reticle, photomask, mirror, and/or a reticle or photomask holder.

Each sample 415 has substantially uniform refractive index, hydroxyl (OH) concentration, and titania (TiO₂) concentration across the length and width of the sample. In order to determine the uniformity of the samples in a glass body, each sample 415 is divided into segments across the length and width of the sample. For example, FIG. 5B shows sample 415 divided into segments 420 across the cross-sectional length L′ and width W′ of sample 415. The refractive index and the concentration of one or more components (e.g., hydroxyl, titania) may be then determined for each segment 420 in order to determine the uniformity of each of these components along sample 415. For example, the refractive index may be measured for each segment 420 in order to determine the refractive index uniformity across the cross-section of sample 415. As another example, the concentration of hydroxyl may be measured for each segment 420 in order to determine the hydroxyl concentration uniformity across the cross-section of sample 415. Furthermore, the concentration of titania may be determined for each segment 420 in order to determine the titania concentration uniformity across the cross-section of sample 415. As discussed further below, the concentration of the one or more components is determined through the full thickness h′ of each segment 420.

Although FIG. 5B shows segments 420 as extending along the entire length L′ and width W′ of sample 415, it is also contemplated that the portion of sample 415 that comprises segments 420 may be less than the entire cross-sectional length L′ and width W′. For example, as shown in FIG. 5C, sample 415 may comprise an outer, peripheral lip 417 upon which segments 420 are not formed. Therefore, outer, peripheral lip 417 may be a clearance between the end of segments 420 and the outer edge of sample 415. In embodiments, the outer, peripheral lip may extend for a length L′″ from about 2 mm to about 20 mm, or about 4 mm to about 16 mm, or about 5 mm to about 16 mm, or about 8 mm to about 14 mm, or about 10 mm to about 12 mm. In some embodiments, the length L′″ is about 12.5 mm or about 12.7 mm.

Segments 20 may be adjacent segments across a specific length and width of sample 415 such that segments 420 span the entire area formed by this specific length and width. As discussed above, this specific length and width may be equal to or less than the length L′ and width W′ of sample 415. In embodiments, segments 420 are adjacent segments (with no gaps therebetween) across a length and width of sample 415 such that the length and width are each about 25 mm or greater, or about 30 mm or greater, or about 40 mm or greater or about 50 mm or greater, or about 60 mm or greater, or about 75 mm or greater, or about 100 mm or greater, or about 125 mm or greater, or about 150 mm or greater, or about 175 mm or greater, or about 180 mm or greater, or about 190 mm or greater, or about 200 mm or greater, or about 250 mm or greater, or about 500 mm or greater, or about 700 mm or greater, or about 800 mm or greater, or about 900 mm or greater, or about 1000 mm or greater, or about 1100 mm or greater, or about 1200 mm or greater, or about 1500 mm or greater, or about 1700 mm or greater, or about 2000 mm or greater. In some embodiments, segments 420 are adjacent segments across a length and width of sample 415 such that the length and width are each about 530 mm or about 1200 mm.

When sample 415 comprises a flat surface, segments 420 are formed along the flat planar surface, as shown in FIG. 5B. However, when sample 515 comprises a concave or convex surface, segments 420 are formed along the curving surface of sample 415.

As shown in FIG. 5B, each segment 420 has a length L″ and a width W″ that are each about 12.7 mm. However, embodiments of the present disclosure encompass other length L″ and width W″ values and are not limited to 12.7 mm. It is also contemplated in embodiments that the length L″ is not equal to the width W″. Furthermore, it is noted that in some embodiments, the length L″ and the width W″ of segments 420 may be equal to the length L″ of peripheral lip 417.

The height of each segment 420 is the height h′ of sample 15, as discussed above. Therefore, in embodiments, the height h′ is about 7.62 mm.

As discussed above, the refractive index may be determined within each segment 420 and the concentration of one or more components may be determined within each segment 420. Therefore, for example, the concentration of hydroxyl and/or the concentration of titania may be determined for each adjacent segment 420 within sample 415. When each segment 20 has a length and width of 12.7 mm, the refractive index and the concentration of the components is determined at a frequency of 12.7 mm across the cross-section of sample 415. For example, the concentration of hydroxyl is measured at a frequency of 12.7 mm across the cross-section of sample 415.

An optical interferometer operating at a wavelength of 633 nm is used to measure the refractive index of each segment 420. In particular, the optical interferometer is a Zygo Verifire HD from Zygo Corporation with a 270 micron pixel size resolution and operating at a wavelength of 633 nm. The optical interferometer is set so that the pixels are square with a size of 270 microns×270 microns, and each pixel extends through the full thickness h′ of sample 415. The refractive index is measured at each pixel within a segment 420 and through the full thickness of the pixel. The refractive indexes, which were each measured for each pixel within a segment 420, are then averaged together to determine the average refractive index of each segment 420. The refractive index measurement is then repeated over all segments 420 of sample 415.

The concentration of hydroxyl for each segment 420 is measured using Fourier transform infrared spectroscopy (“FTIR”) in transmission. As used herein, “in transmission” means that the light is directed through the glass body to be measured to determine the hydroxyl concentration (rather than using light that is reflected from the body to be measured to determine the hydroxyl concentration). Therefore, “in transmission” requires a non-scattering surface. Once sample 415 is loaded into the FTIR for measurement, a beam alignment and background measurement may be performed first. Then the FTIR measures the fundamental absorption peak for hydroxyl, which measures the peak height with respect to the background signal, the background signal being a straight line between the points surrounding the absorption peak. The absorption peak height is then divided by the thickness (h) of sample 415 to yield an absorption coefficient β_{OH}. The hydroxyl concentration is then derived from the absorption coefficient β_{OH} using the equation:

C=β_{OH}/ε×MW_{OH}/Dglass×106

where C is the concentration of hydroxyl in ppm for a particular segment 420, β_{OH}n is the absorption coefficient of the glass, & is the molar absorptivity of hydroxyl for the absorption peak at a wavenumber of 3670 cm⁻¹, MW_{OH} is the molecular weight of hydroxyl (g/mol), and D is the density of hydroxyl (g/cm³). The above-disclosed FTIR analysis is further disclosed in K. M. Davis, et al, “Quantitative infrared spectroscopic measurement of hydroxyl concentration in silica glass,” J. Non-Crystalline Solids, 203 (1996) 27-36, which is incorporated by reference herein. As discussed above, the hydroxyl concentration is measured for each segment 420 of sample 415 and is measured through the full thickness h′ of each segment 420. The hydroxyl concentration measurement is then repeated over all segments 420 of sample 415.

The concentration of titania of each segment 420 is calculated based upon the measured refractive index of each segment 420. More specifically, the average titania concentration of each segment 420 is determined based upon the average refractive index of each segment 420 using the following relationship:

55ppm RI=0.0125% C_{Ti}

wherein RI is the average refractive index of each segment 420 and C_{Ti} is the average concentration of titania (in wt. %) of each segment 420. It is noted that the above relationship assumes that the only influence on the change of refractive index is from titania.

Furthermore, the average CTE of each segment 420 is determined from the average refractive index of each segment 420 using the following relationship:

55ppm RI=1ppb/K CTE

wherein RI is the average refractive index of each segment 420 and CTE is the average coefficient of thermal expansion (in ppb/K) of each segment 420. It is noted that the above relationship assumes that the only influence on the change of refractive index is from CTE.

Additionally, the Tzc of each segment 420 is determined from the CTE of each segment 420 using the following relationship:

ΔCTE/CTE slope=ΔTzc

wherein ΔCTE is the deviation of CTE for a particular segment 420 as compared to the average CTE of all the segments 420 (in ppb/K), CTE slope is the slope of CTE of all the segments 420 as a function of temperature (in ppb/K²), and ΔTzc is the deviation of Tzc for the particular segment 420 as compared to the average Tzc of all the segments 20 (°C). It is noted that the above relationship assumes that the only influence on the change of Tzc is from CTE. In the embodiments disclosed herein, the CTE slope is from about 1.0 ppb/K² to about 2.5 ppb/K², or about 1.15 ppb/K² to about 2.0 ppb/K², or about 1.2 ppb/K² to about 1.9 ppb/K², or about 1.3 ppb/K² to about 1.7 ppb/K².

One or more segments 420 may have a different concentration of one or more components from one or more other segments 420. For example, one or more segments 420 may have a different average concentration of hydroxyl from one or more other segments 420. Additionally or alternatively one or more segments 420 may have a different average concentration of titania from one or more other segments 420.

In some embodiments, the concentration of hydroxyl may be in a gradient that extends radially outward along sample 415 with the highest hydroxyl concentrations a radial center point of sample 415, such that the segments gradually decrease in hydroxyl concentration radially outward from the center point. In these embodiments, the segments near the center point sample 415 have the highest concentration of hydroxyl while the segments near the peripheral edges of sample 415 have the lowest concentration of hydroxyl.

In yet other embodiments, the segments 420 closer to a peripheral edge of sample 415 may have a higher concentration of hydroxyl than the other segments.

It is also contemplated, in some embodiments, that segments 420 all have the same concentration (or substantially the same concentration) of hydroxyl.

Furthermore, one or more segments 420 may have the same or different concentration of titania. In some embodiments, the concentration of titania may be the same (or substantially the same) across segments 420. Therefore, in some embodiments, the concentration of titania may be evenly distributed among segments 420.

The average concentration of each segment 420 may be averaged together to determine an average concentration across the cross-section of sample 415. For example, the average concentration of hydroxyl of each segment 420 may be measured (as discussed above) and each of these concentrations may be averaged together to determine the average hydroxyl concentration across an entirety of sample 415. More specifically, in embodiments when sample 415 comprises 144 segments 420, the hydroxyl concentrations of the 144 segments4 20 are averaged together to determine the average concentration of hydroxyl of the entirety of sample 415. It is also noted that the average concentrations across sample 415 may extend for a specific length and width across sample, which are less than the entire length L′ and width W′ of sample 415.

According to the embodiments disclosed herein, the average hydroxyl concentration across sample 415 may be about 5 ppm or greater, or about 10 ppm or greater, or about 20 ppm or greater, or about 30 ppm or greater, or about 40 ppm or greater, or about 50 ppm or greater, or about 75 ppm or greater, or about 100 ppm or greater, or about 125 ppm or greater, or about 150 ppm or greater, or about 175 ppm or greater, or about 200 ppm or greater, or about 250 ppm or greater, or about 300 ppm or greater, or about 400 ppm or greater, or about 500 ppm or greater, or about 600 ppm or greater, or about 700 ppm or greater, or about 800 ppm or greater, or about 900 ppm or greater, or about 1000 ppm or greater, or about 1100 ppm or greater, or about 1200 ppm or greater, or about 1300 ppm or greater, or about 1400 ppm or greater, or about 1500 ppm or greater, or about 2000 ppm or greater. Additionally or alternatively, the average hydroxyl concentration across sample 415 may be about 2000 ppm or less, or about 1500 ppm or less, or about 1400 ppm or less, or about 1300 ppm or less, or about 1200 ppm or less, or about 1100 ppm or less, or about 1000 ppm or less, or about 900 ppm or less, or about 800 ppm or less, or about 700 ppm or less, or about 600 ppm or less, or about 500 ppm or less, or about 400 ppm or less, or about 300 ppm or less, or about 250 ppm or less, or about 200 ppm or less, or about 175 ppm or less, or about 150 ppm or less, or about 125 ppm or less, or about 100 ppm or less, or about 75 ppm or less, or about 50 ppm or less, or about 40 ppm or less, or about 30 ppm or less, or about 20 ppm or less, or about 10 ppm or less, or about 5 ppm or less. In embodiments, the average hydroxyl concentration is in a range from about 0 ppm to about 2000 ppm, or about 200 ppm to about 1900 ppm, or about 300 ppm to about 1800 ppm, or about 400 ppm to about 1700 ppm, or about 500 ppm to about 1750 ppm, or about 600 ppm to about 1600 ppm, or about 700 ppm to about 1500 ppm, or about 800 ppm to about 1400 ppm, or about 900 ppm to about 1300 ppm, or about 1000 ppm to about 2000 ppm, or about 1000 ppm to about 1500 ppm, or about 1000 ppm to about 1200 ppm, or about 1000 ppm to about 1100 ppm, or about 600 ppm to about 1500 ppm, or about 600 ppm to about 1400 ppm, or about 600 ppm to about 1300 ppm, or about 700 ppm to about 1000 ppm, or about 20 ppm to about 450 ppm, or about 50 ppm to about 200 ppm, or about 75 ppm to about 150 ppm, or about 80 ppm to about 125 ppm, or about 80 ppm to about 500 ppm, or about 80 ppm to about 400 ppm, or about 80 ppm to about 300 ppm, or about 80 ppm to about 200 ppm.

In some particular embodiments, the maximum hydroxyl concentration among segments 420 may be in a range from about 1000 ppm to about 1400 ppm, or from about 1000 ppm to about 1300 ppm, or from about 1000 ppm to about 1200 ppm, or from about 1000 ppm to about 1100 ppm, or from about 1050 ppm to about 1100 ppm, or from about 1060 ppm to about 1090 ppm, or from about 100 ppm to about 600 ppm, or from about 200 ppm to about 500 ppm, or from about 300 ppm to about 400 ppm. The minimum hydroxyl concentration among segments 20, in some particular embodiments, may be in a range from about 900 ppm to about 1300 ppm, or from about 900 ppm to about 1200 ppm, or from about 900 ppm to about 1100 ppm, or from about 1000 ppm to about 1100 ppm, or from about 1050 ppm to about 1100 ppm, or from about 1060 ppm to about 1080 ppm, or from about 100 ppm to about 600 ppm, or from about 200 ppm to about 500 ppm, or from about 300 ppm to about 400 ppm.

The average titania (TiO₂) concentration across sample 415 may be from about 1.0 wt. % to about 15.0 wt. %, or from about 6.0 wt. % to about 12.0 wt. %, or from about 6.0 wt. % to about 8.5 wt. %, or from about 6.5 wt. % to about 8.0 wt. %, or from about 7.0 wt. % to about 7.7 wt. %, or from about 6.5 wt. % to about 7.8 wt. %.

The difference between the highest average concentration and the lowest average concentration of the one or more components among the different segments 20 is also determined. More specifically, the segment 420 with the highest average value of a particular component (e.g., refractive index, hydroxyl concentration, or titania concentration) is compared with the segment 420 with the lowest average value of that particular component. Then, the difference between the highest and lowest average values of that particular component is calculated. This difference between the highest average value and the lowest average value in a sample 415 is referred to as the peak-to-valley (P-V) difference.

The P-V difference of average refractive index of segments 420 across sample 415 may be about 1×10⁻⁴ or less, or about 5×10⁻⁵ or less, or about 1×10⁻⁵ or less, or about 5×10⁻⁶ or less, or about 1×10⁻⁶ or less, or about 5×10⁻⁷ or less, or about 1×10⁻⁷ or less, or from about 1×10⁻⁶ to about 1×10⁻⁴, or about 6×10⁻⁶ to about 9×10⁻⁵, or about 10×10⁻⁶ to about 6×10⁻⁵, or about 1×10⁻⁶ to about 1×10⁻⁵, or about 1×10⁻⁵ to about 1×10⁻⁴. The distribution of refractive index within a glass body is an indicator of the titania concentration distribution of that glass body. Therefore, a glass body with a smaller P-V difference in refractive index will also have a smaller P-V difference of titania. As discussed above, a smaller P-V difference of titania allows the glass body to be more uniformly polished.

The P-V difference of hydroxyl concentration of segments 420 in sample 415 may be about 100 ppm or less, or about 90 ppm or less, or about 80 ppm or less, or about 70 ppm or less, or about 60 ppm or less, or about 55 ppm or less, or about 50 ppm or less, or about 45 ppm or less, or about 40 ppm or less, or about 35 ppm or less, or about 30 ppm or less, or about 25 ppm or less, or about 20 ppm or less, or about 15 ppm or less, or about 10 ppm or less, or about 5.0 ppm or less, or about 2.5 ppm or less, or about 1.0 ppm or less, or about 0.0 ppm. Additionally or alternatively, the P-V difference of hydroxyl concentration of segments 420 may be about 0.0 ppm or greater, or about 1.0 ppm or greater, or about 2.5 ppm or greater, or about 5.0 ppm or greater, or about 10 ppm or greater, or about 15 ppm or greater, or about 20 ppm or greater, or about 25 ppm or greater, or about 30 ppm or greater, or about 35 ppm or greater, or about 40 ppm or greater, or about 45 ppm or greater, or about 50 ppm or greater. In some embodiments, the P-V difference of average hydroxyl concentration of segments 420 is within a range of about 0.0 ppm to about 60 ppm, or about 10 ppm to about 50 ppm, or about 15 ppm to about 45 ppm, or about 20 ppm to about 40 ppm, or about 10 ppm to about 30 ppm.

The P-V difference of titania concentration of segments 420 in sample 415 may be about 0.0040 wt. % or less, or about 0.0035 wt. % or less, or about 0.0030 wt. % or less, or about 0.0025 wt. % or less, or about 0.0020 wt. % or less, or about 0.0015 wt. % or less, or about 0.0010 wt. % or less. In embodiments, the P-V difference of titania concentration of segments 420 is in range from about 0.0010 wt. % to about 0.0050 wt. %, or about 0.0015 wt. % to about 0.0045 wt. %, or about 0.0020 wt. % to about 0.0040 wt. %, or about 0.0025 wt. % to about 0.0035 wt. %, or about 0.0030 wt. % to about 0.0050 wt. %, or about 0.0010 wt. % to about 0.0030 wt. %, or about 0.0010 wt. % to about 0.0025 wt. %, or about 0.0010 wt. % to about 0.0020 wt. %.

As discussed above, the P-V difference of refractive index and of the concentrations of both hydroxyl and titania are very low, thus providing a homogenous glass body 400. Due to such low P-V differences, glass body 400 can be efficiently polished to provide an even surface with high flatness.

Additionally, as discussed above, the average Tzc, average refractive index, and average CTE of each segment 420 is determined. One or more segments 420 may differ in these properties from one or more other segment 420. Therefore, for example, a first segment 420 may have a different average Tzc and/or a different average refractive index from a second segment 420.

The P-V difference of average Tzc in segments 420 across sample 415 may be from about 0.050 °C to about 0.300 °C, or from about 0.075 °C to about 0.250 °C, or from about 0.080 °C to about 0.200 °C, or from about 0.100 °C to about 0.190 °C, or from about 0.120 °C to about 0.180 °C, or from about 0.140 °C to about 0.160 °C, or from about 0.050 °C to about 0.180 °C, or from about 0.100 °C to about 0.140 °C. Due to the low P-V difference of average Tzc in segments 420, glass body 400 is able to maintain its surface shape (“figure”) when subject to temperature changes in an EUV lithography system.

The average Tzc of segments 420 across sample 415 may be in a range from about 20 °C to about 60 °C, or from about 25 °C to about 55 °C, or from about 30 °C to about 50 °C, or from about 35 °C to about 45 °C, or from about 40 °C to about 45 °C, or from about 20 °C to about 45 °C, or from about 20 °C to about 40 °C, or from about 10 °C to about 50 °C.

The P-V difference of average CTE of segments 420 across sample 415 may be from about 0.30 ppb/K or less, or about 0.25 ppb/K or less, or about 0.20 ppb/K or less, or about 0.15 ppb/K or less, or about 0.12 ppb/K or less, or about 0.10 ppb/K or less, or about 0.05 ppb/K or less. In the embodiments, the P-V difference of average CTE of segments 420 across sample 415 is in a range from about 0.05 ppb/K to about 0.25 ppb/K, or about 0.07 ppb/K to about 0.20 ppb/K, or about 0.08 ppb/K to about 0.18 ppb/K, or about 0.09 ppb/K to about 0.16 ppb/K, or about 0.10 ppb/K to about 0.15.

The average CTE of each segment 420 is about −30 ppb/K to about +30 ppb/K at a temperature between 288K and 303K. In some embodiments the CTE is about −10 ppb/K to about +10 ppb/K at a temperature between 288K and 303K, or about −5 ppb/K to about +5 ppb/K at a temperature between 288K and 303K, or about −2 ppb/K to about +2 ppb/K at a temperature between 288K and 303K.

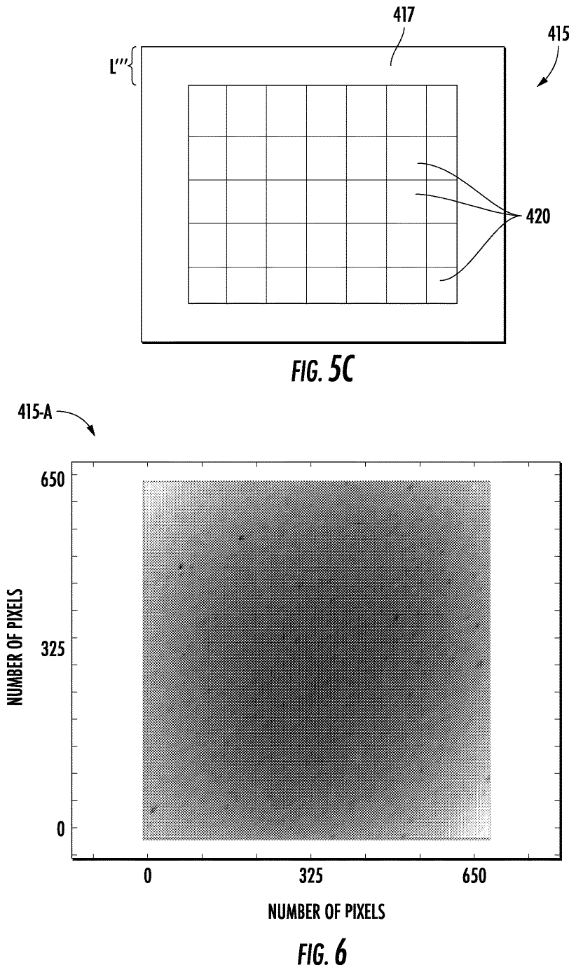

FIG. 6 shows the refractive index variation for a sample 415-A made using process 200 of FIG and, thus, made according to the embodiments of the present disclosure. Each pixel in FIG. 6 represents a segment 420 with a length L″ and a width W″ of 0.269 mm. Therefore, sample 415-A comprises 650 segments 420 across its length L″ and 650 segments across its width W″. The gray scale in FIG. 6 represents a change in refractive index, with darker gray pixels corresponding to relatively higher refractive index values and lighter gray pixels corresponding to relatively lower refractive index values. As shown in FIG. 6, the refractive index is uniform across the entirety of the sample 415-A with very little variation.

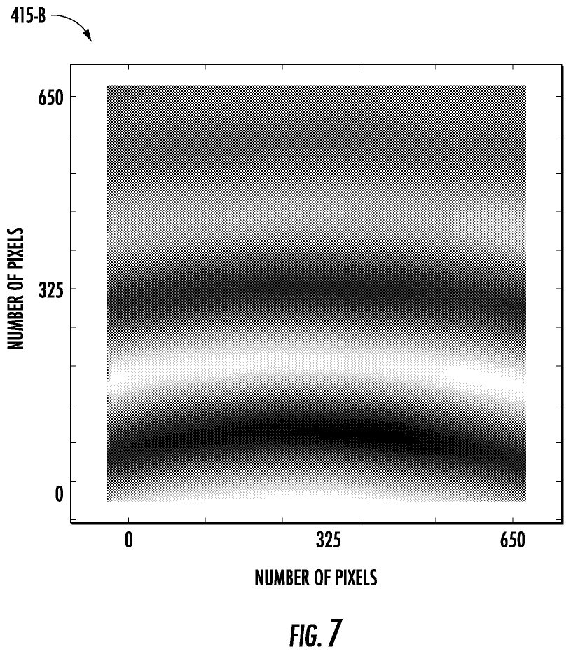

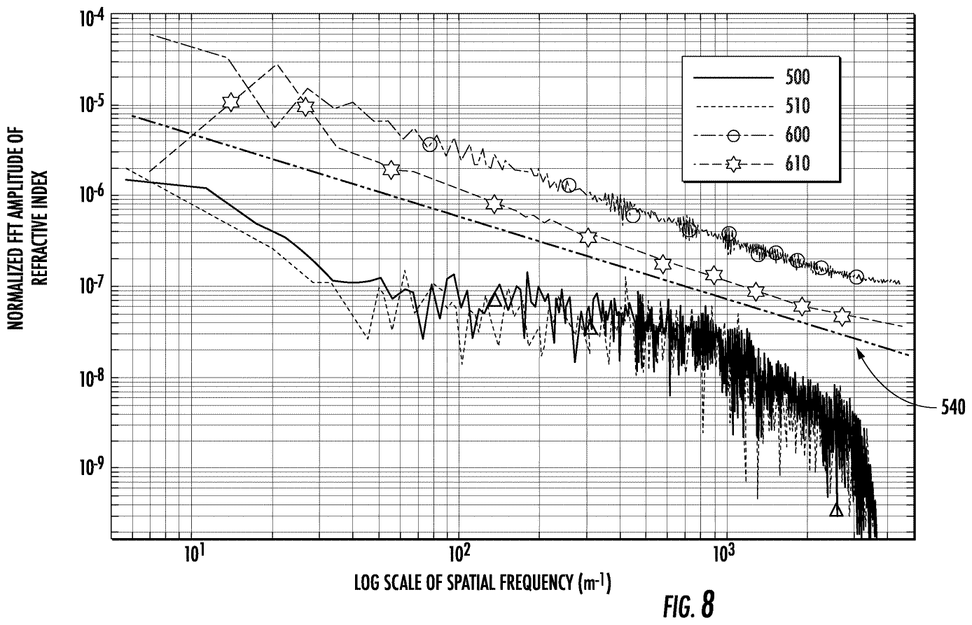

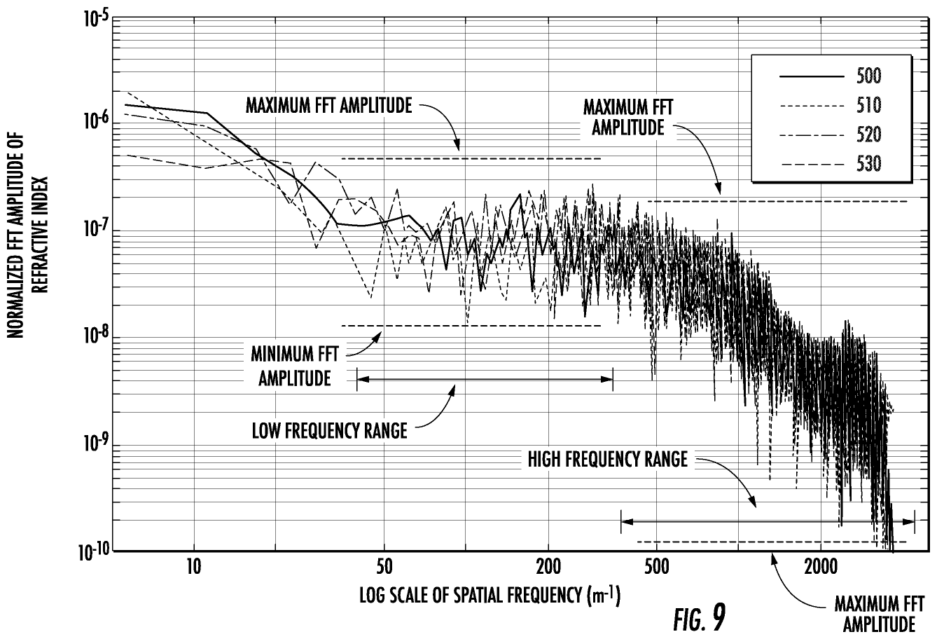

FIG. 7 shows the refractive index variation for a comparative sample 415-B made using the conventional boule process of FIG. 1. Similar to FIG. 6, each pixel in FIG. 7 represents a segment 420 with a length L″ and a width W″ of 0.269 mm. Therefore, sample 415-B comprises 650 segments 420 across its length L″ and 650 segments across its width W″. The gray scale in FIG. 7 also represents a change in refractive index, with darker gray pixels corresponding to relatively higher refractive index values and lighter gray pixels corresponding to relatively lower refractive index values. As shown in FIG. 7, the comparative sample 415-B includes striations in the refractive index such that the conventional sample of FIG. 7 is not as uniform as the exemplary sample 415-A of FIG. 6. Furthermore, the refractive index P-V of comparative sample 415-B is higher than that of exemplary sample 415-A.

The refractive index measurements disclosed herein were subjected to fast Fourier transform (“FFT”) to map the analog signal time data into a frequency domain. Through the FFT, the analog time domain is mapped into the frequency domain, thereby isolating frequency components from each other and enabling the identification of the magnitude of each frequency component. It is known that if a time domain signal x(n) consists of N samples and W is the frequency response, X(k) can be calculated by using the discrete Fourier transform:

$$X ( k ) = \frac{1}{N} {\sum }_{n = 0}^{N - 1} x ( n ) {W}_{N}^{Nk} , where k = 0 , 1 , 2 , … N - 1$$

wherein X(k) represents the FFT signal and W is defined by the following equation:

$$W = {e}^{- i 2 π \frac{k}{N} n} .$$

In performing a Fast Fourier Transform, the signal is broken down into equal parts made up of odd and even samples. The first part performs a discrete Fourier transform operation on the even samples, and the second part performs a similar operation on the odd samples. The results are then combined, which performs an N point recombination operation. The recombination process is used to combine the samples into the correct order, which is carried out using a butterfly network, as is known in the art.

For most applications, the time domain signal (x(n)) is real and its frequency domain signal (X(k)) is symmetrical, i.e., if X(k) is the FFT of a real signal x(n), it satisfies X(k)=X*(N−k), for k=1, . . . , N/2-1 where Nis the length of the FFT and * represents the complex conjugate.

For purposes of the present disclosure, the FFT is calculated using the COMSOL® software, in particular, the Multiphysics version 6.3 and the specialized module Spatial FFT. The glass bodies were first segmented into samples 415, each with a length L′ of 175 mm, a width W′ of 175 mm, and a height h′ of 7.62 mm. The refractive index of the sample 415 was measured using the Zygo Verifire HD optical interferometer from Zygo Corporation with a 270 micron pixel size resolution and operating at a wavelength of 633 nm, as discussed above. In particular, the refractive index was measured at each pixel along the sample 415 such that the sample 415 included 650 pixels along its length L′ and 650 samples along its width W′. The refractive index data set was imported into the COMSOL® software. From this data set, a one-dimensional data series consisting of approximately 650 points was extracted along a central line of the sample 415 in either the x-direction or y-direction of the sample 415 to ensure a representative sample of the refractive index variations.

The Spatial FFT module in COMSOL® was employed to compute the frequency domain coefficients of the one-dimensional refractive index data set. The frequency domain coefficients correspond to the frequency components of the refractive index variations of the one-dimensional refractive index data set. To quantify the spectral characteristics, the amplitude spectrum at each frequency was determined by calculating the absolute value of the FFT coefficients. The resulting amplitude spectrum was normalized by dividing each value by the total number of data points in the series to ensure consistency.

The FFT of refractive index variation shows how quickly the refractive index P-V changes over the glass body. Therefore, a relatively lower FFT amplitude corresponds to a relatively more uniform refractive index variation as compared to a relatively higher FFT amplitude. As is known in the art, FFT is plotted over a spatial frequency range, wherein relatively lower frequency ranges are an indicator of long, slow changes of refractive index in the glass body and relatively higher frequency ranges are an indicator of short, fast changes of refractive index in the glass body.

FIG. 8 shows the FFT plot of two exemplary examples and two comparative examples over a spatial frequency range. It is noted that the x-axis in FIG. 8 represents the spatial frequency range in log scale and that the y-axis in FIG. 8 represents the normalized FFT amplitude of refractive index variation. Exemplary Example 500 is a glass body produced using the steps of process 200 and comprises an average refractive index of 1.48, an average TiO₂ concentration of 6.85 wt. %, an average SiO₂ concentration of 93.14 wt. %, an average OH concentration of 880 ppm, and a P-V OH of 93 ppm. Exemplary Example 510 is a glass body produced using the steps of process 200 and comprises an average refractive index of 1.48, an average TiO₂ concentration of 7.58 wt. %, an average SiO₂ concentration of 92.17 wt. %, an average OH concentration of 875 ppm, and a P-V OH of 81.2 ppm. Comparative Examples 600 and 610 were produced using the conventional boule process of FIG. 1 and each comprise an average refractive index of 1.48, an average TiO₂ concentration of about 7.7 wt. %, an average SiO₂ concentration of about 92.2 wt. %, and an average OH concentration of about 870 ppm.

As shown in FIG. 8, Exemplary Examples 500 and 510 comprise a lower FFT amplitude over the spatial frequency range from 5 m⁻¹ to 3,000 m⁻¹ as compared with Comparative Examples 600 and 610. More specifically, line 540 in FIG. 8 separates the exemplary examples from the comparative examples. Line 540 is represented by the equation:

y=10^{a}·x^{b}

wherein a is equal to −4.15 and b is equal to −1.

In the embodiments of the present disclosure, the glass bodies produced with process 200 of FIG. 2 have a FFT amplitude of refractive index variation at line 540 and below at every frequency over a spatial frequency range from 5 m⁻¹ to 3,000 m⁻¹. In particular, the glass bodies produced with process 200 of FIG. 2 have a FFT amplitude of refractive index variation that satisfies the following equation over a spatial frequency range from 5 m⁻¹ to 3,000 m⁻¹:

y≤10^{a}·x^{b}

wherein a is equal to about −3.85 or less, or about −3.90 or less, or about −3.95 or less, or about −4.00 or less, or about −4.05 or less, or about −4.10 or less, or about −4.15 or less, or any range or combination of ranges encompassing these endpoints and b is equal to about −1.0. In some embodiments, a is in a range from about −4.15 to about −3.85, or about −4.10 to about −3.90, or about −4.05 to about −3.95, or about −4.00 to about −4.05.

Furthermore, in the embodiments disclosed herein, the glass bodies produced with process 200 of FIG. 2 all have a maximum FFT amplitude of refractive index variation of about 1.0×10⁻⁶ or less, or about 9.0×10⁻⁷ or less, or about 8.0×10⁻⁷ or less, or about 7.0×10⁻⁷ or less, or about 6.0×10⁻⁷ or less, or about 5.0×10⁻⁷ or less, or about 4.0×10⁻⁷ or less, or about 3.0×10⁻⁷ or less, or about 2.0×10⁻⁷ or less, or about 1.8×10⁻⁷ or less, or about 1.6×10⁻⁷ or less, or about 1.4×10⁻⁷ or less, or about 1.2×10⁻⁷, or less, or about 1.0×10⁻⁷ or less, or any range or combination of ranges encompassing these endpoints and all have a minimum FFT amplitude of refractive index variation of about 1.0×10⁻⁹ or greater, or about 2.0×10⁻⁹ or greater, or about 3.0×10⁻⁹ or greater, or about 4.0×10⁻⁹ or greater, or about 5.0×10⁻⁹ or greater, or about 6.0×10⁻⁹ or greater, or about 7.0×10⁻⁹ or greater, or about 8.0×10⁻⁹ or greater, or about 9.0×10⁻⁹ or greater, or about 1.0×10⁻⁸ or greater, or about 1.1×10⁻⁸ or greater, or about 1.2×10⁻⁸ or greater, or about 1.3×10⁻⁸ or greater, or any range or combination of ranges encompassing these endpoints over the low spatial frequency range from 30 m⁻¹ to 500 m⁻¹.

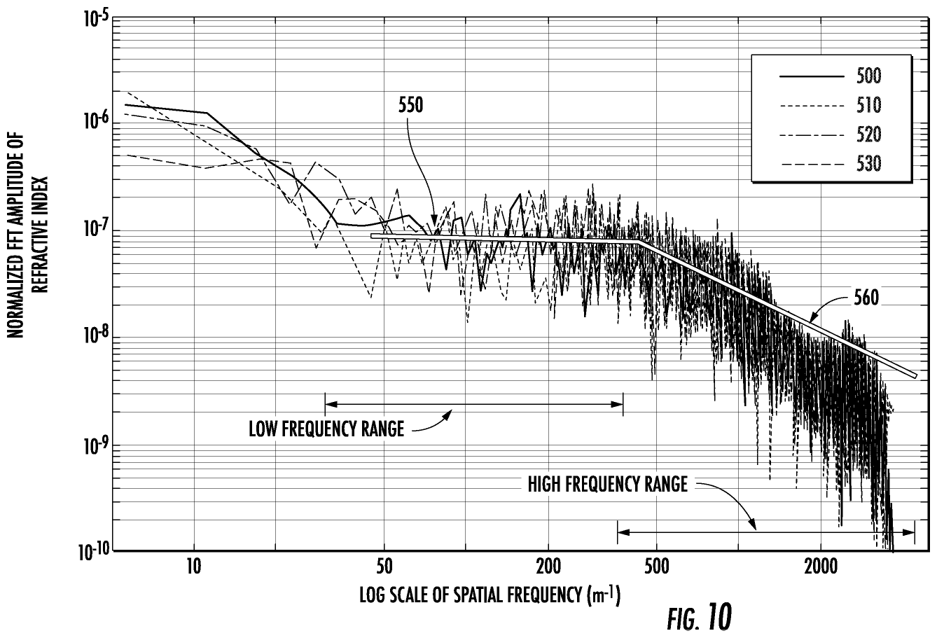

And the glass bodies produced with process 200 of FIG. 2 all have a maximum FFT amplitude of refractive index variation of about 2.0×10⁻⁶ or less, or about 1.7×10⁻⁶ or less, or about 1.5×10⁻⁶ or less, or about 1.2×10⁻⁶ or less, or about 1.0×10⁻⁶ or less, or about 9.0×10⁻⁷ or less, or about 8.0×10⁻⁷ or less, or about 6.0×10⁻⁷ or less, or about 5.0×10⁻⁷ or less, or about 4.0×10⁻⁷ or less, or about 3.0×10⁻⁷ or less, or about 2.0×10⁻⁷ or less, or any range or combination of ranges encompassing these endpoints and a minimum FFT amplitude of refractive index variation of about 0.0×10⁻¹¹ or greater, or about 1.0×10⁻¹¹ or greater, or about 1.5×10⁻¹¹ or greater, or about 2.0×10⁻¹¹ or greater, or about 2.5×10⁻¹¹ or greater, or about 3.0×10⁻¹¹ or greater, or about 3.5×10⁻¹¹ or greater, or about 4.0×10⁻¹¹ or greater, or about 4.5×10⁻¹¹ or greater, or about 5.0×10-11 or greater, or about 6.0×10⁻¹¹ or greater, or about 7.0×10⁻¹¹ or greater, or about 8.0×10⁻¹¹ or greater, or about 9.0×10⁻¹¹ or greater, or about 1.0×10⁻¹⁰ or greater, or any range or combination of ranges encompassing these endpoints over the high spatial frequency range of 500 m⁻¹ to 3,000 m⁻¹. This is further shown in FIG. 9 with Exemplary Examples 500 and 510 along with Exemplary Examples 520 and 530.

In embodiments, as shown in FIG. 9, the maximum FFT amplitude of refractive index variation over the low spatial frequency range from 30 m⁻¹ to 500 m⁻¹ is greater than the maximum FFT amplitude of refractive index variation over the high spatial frequency range of 500 m⁻¹ to 3,000 m⁻¹. Furthermore, in embodiments, minimum FFT of refractive index variation over the low spatial frequency range from 30 m⁻¹ to 500 m⁻¹ is greater than the minimum FFT amplitude of refractive index variation over the high spatial frequency range of 500 m⁻¹ to 3,000 m⁻¹.

Exemplary Example 520 is a glass body produced using the steps of process 200 and comprises an average refractive index of 1.48, an average TiO₂ concentration of 7.61 wt. %, an average SiO₂ concentration of 92.53 wt. %, an average OH concentration of 832 ppm, and a P-V OH of 13 ppm. Exemplary Example 530 is a glass body produced using the steps of process 200 and comprises an average refractive index of 1.48, an average TiO₂ concentration of 7.61 wt. %, an average SiO₂ concentration of 92.53 wt. %, an average OH concentration of 835 ppm, and a P-V OH of 345 ppm.

FIG. 9 shows the FFT amplitude of refractive index variation of Exemplary Examples 500, 510, 520, and 530. Similar to FIG. 8, the x-axis in FIG. 9 represents the spatial frequency range in log scale and that the y-axis in FIG. 9 represents the normalized FFT amplitude of refractive index variation. As shown in FIG. 9, over the low spatial frequency range of 30 m⁻¹ to 500 m⁻¹, the Exemplary Examples 500, 510, 520, 530 all have a maximum FFT amplitude of 1.0×10⁻⁶ or less and all have a minimum FFT amplitude of 1.0×10⁻⁹ or greater. Furthermore, over the high spatial frequency range of 500 m⁻¹ to 3,000 m⁻¹, the Exemplary Examples 500, 510, 520, and 530 all have a maximum FFT amplitude of 2.0×10⁻⁶ or less and all have a minimum FFT amplitude of 0.0×10⁻¹¹ or greater.

FIG. 10 shows the same FFT amplitude vs. spatial frequency (in log scale) for Exemplary Examples 500, 510, 520, 530 as that shown in FIG. 9. As shown in FIG. 10, for the exemplary embodiments disclosed herein, a best fit line 550 within the low spatial frequency range of 30 m⁻¹ to 500 m⁻¹ is represented by the following equation:

y=10^{c}·x^{d}

wherein c is in a range from about −7.85 to about −6.35, or from about −7.80 to about −6.40, or about −7.75 to about −6.45, or about −7.70 to about −6.50, or about −7.65 to about −6.55, or about −7.60 to about −6.60, or about −7.55 to about −6.65, or about −7.50 to about −6.70, or about −7.45 to about −6.75, or about −7.40 to about −6.80, or about −7.35 to about −6.85, or about −7.30 to about −6.90, or about −7.25 to about −6.95, or about −7.20 to about −7.00, or about −7.15 to about −7.05, or about −7.10 to about −7.05, or any range or combination of ranges encompassing these endpoints and d is in a range from about −0.70 to 0.00, or about −0.65 to about −0.05, or about −0.60 to about −0.10, or about −0.55 to about −0.15, or about −0.50 to about −0.20, or about −0.45 to about −0.25, or about −0.40 to about −0.30, or about −0.35 to about −0.30, or any range or combination of ranges encompassing these endpoints. In some embodiments, d is about −0.3.70.

As also shown in FIG. 10, for the exemplary embodiments disclosed herein, a best fit line 560 within the high spatial frequency range of 500 m⁻¹ to 3,000 m⁻¹ is represented by the following equation:

y=10^{e}·x^{f}

wherein e is in a range from about −3.85 to about −1.65, or about −3.80 to about −1.70, or about −3.75 to about −1.75, or about −3.70 to about −1.80, or about −3.65 to about −1.85, or about −3.60 to about −1.90, or about −3.55 to about −1.95, or about −3.50 to about −2.00, or about −3.45 to about −2.05, or about −3.40 to about −2.10, or about −3.35 to about −2.15, or about −3.30 to about −2.20, or about −3.25 to about −2.25, or about −3.20 to about −2.30, or about −3.15 to about −2.35, or about −3.10 to about −2.40, or about −3.05 to about −2.45, or about −3.00 to about −2.50, or about −2.95 to about −2.55, or about −2.90 to about −2.60, or about −2.85 to about −2.65, or about −2.80 to about −2.70, or about −2.75 to about −2.70, or any range or combination of ranges encompassing these endpoints and f is in a range from about −2.0 to about −1.2, or about −1.95 to about −1.25, or about −1.90 to about −1.30, or about −1.85 to about −1.35, or about −1.80 to about −1.40, or about −1.75 to about −1.45, or about −1.70 to about −1.50, or about −1.65 to about −1.55, or about −1.60 to about −1.55, or any range or combination of ranges encompassing these endpoints.

According to a first aspect, a glass body comprising an SiO₂ concentration of about 80 wt. % or more and a TiO₂ concentration of about 6.0 wt. % to about 12.0 wt. %, wherein a fast Fourier transform amplitude spectrum of refractive index variation of the glass body satisfies the following equation over a spatial frequency range from 5 m⁻¹ to 3,000 m⁻¹:y≤10^{a}·x^{b}, wherein a is equal to about −3.85 or less and b is equal to about −1.0.

According to a second aspect, the glass body of the first aspect, wherein a is about −4.00 or less.

According to a third aspect, the glass body of the first or second aspect, wherein a is in a range from about −4.15 to about −3.85.

According to a fourth aspect, the glass body of any one of the first through third aspects, wherein a P-V of average refractive index of a plurality of segments of the glass body is about 1×10⁻⁴ or less, the plurality of segments including every adjacent segment across a length and a width of the glass body, the length being about 25 mm or more and the width being about 25 mm or more.

According to a fifth aspect, the glass body of the fourth aspect, wherein the P-V of the average refractive index of the plurality of segments of the glass body is about 5×10⁻⁷ or less, the plurality of segments including every adjacent segment across the length and the width of the glass body, the length being about 25 mm or more and the width being about 25 mm or more.

According to a sixth aspect, the glass body of any one of the first through fifth aspects, wherein the glass body comprises a maximum fast Fourier transform amplitude of refractive index variation of about 1.0×10⁻⁶ or less over a spatial frequency range from 30 m⁻¹ to 500 m⁻¹.

According to a seventh aspect, the glass body of any one of the first through sixth aspects, wherein the glass body comprises a minimum fast Fourier transform amplitude of refractive index variation of about 1.0×10⁻⁹ or greater over a spatial frequency range from 30 m⁻¹ to 500 m⁻¹.

According to an eighth aspect, the glass body of any one of the first through seventh aspects, wherein the glass body comprises a maximum fast Fourier transform amplitude of refractive index variation of about 2.0×10⁻⁶ or less over a spatial frequency range from 500 m⁻¹ to 3,000 m⁻¹.

According to a ninth aspect, the glass body of any one of the first through eighth aspects, wherein the glass body comprises a minimum fast Fourier transform amplitude of refractive index variation of about 0.0×10⁻¹¹ or greater over a spatial frequency range from 500 m⁻¹ to 3,000 m⁻¹.

According to a tenth aspect, the glass body of any one of the first through ninth aspects, wherein a best fit line of the Fourier transform amplitude spectrum of refractive index variation of the glass body over a spatial frequency range from f 30 m⁻¹ to 500 m⁻¹ is represented by the following equation: y=10^{c}·x^{d}, wherein a is in c range from about −7.85 to about −6.35 and dis in a range from about −0.70 to 0.00.

According to an eleventh aspect, the glass body of the tenth aspect, wherein c is in a range from about −7.80 to about −6.40 and d is in a range from about −0.65 to about −0.05.

According to twelfth aspect, the glass body of any one of the first through eleventh aspects, wherein a best fit line of the Fourier transform amplitude spectrum of refractive index variation of the glass body over a spatial frequency range from 500 m⁻¹ to 3,000 m⁻¹ is represented by the following equation: y=10^{e}·x^{f}, wherein e is in a range from about −3.85 to about −1.65 and f is in a range from −2.0 to about −0.50.

According to a thirteenth aspect, the glass body of the twelfth aspect, wherein e is in a range from about −3.70 to about −1.80 and f is in a range from about −1.95 to about −1.55.

According to a fourteenth aspect, the glass body of any one of the first through thirteenth aspects, wherein an average hydroxyl concentration of a plurality of segments of the glass body is about 100 ppm or greater, the plurality of segments including every adjacent segment across the length and the width of the glass body, the length being about 25 mm or more and the width being about 25 mm or more.

According to a fifteenth aspect, the glass body of the fourteenth aspect, wherein the average hydroxyl concentration of the plurality of segments of the glass body is in a range from about 200 ppm to about 1900 ppm.

According to a sixteenth aspect, the glass body of any one of the first through fifteenth aspects, wherein a P-V of hydroxyl concentration of a plurality of segments of the glass body is about 100 ppm or less, the plurality of segments including every adjacent segment across the length and the width of the glass body, the length being about 25 mm or more and the width being about 25 mm or more.

According to a seventeenth aspect, the glass body of the sixteenth aspect, wherein the P-V of hydroxyl concentration of the plurality of segments of the glass body is about 60 ppm or less.

According to an eighteenth aspect, the glass body of the seventeenth aspect, wherein the P-V of hydroxyl concentration of the plurality of segments of the glass body is about 30 ppm or less.

According to a nineteenth aspect, the glass body of any one of the first through eighteenth aspects, wherein a P-V of titania concentration of a plurality of segments of the glass body is about 0.0040 wt. % or less, the plurality of segments including every adjacent segment across the length and the width of the glass body, the length being about 25 mm or more and the width being about 25 mm or more.

According to a twentieth aspect, the glass body of any one of the first through nineteenth aspects, wherein a P-V of Tzc of a plurality of segments of the glass body is about 0.050 °C to about 0.300 °C, the plurality of segments including every adjacent segment across the length and the width of the glass body, the length being about 25 mm or more and the width being about 25 mm or more.

According to a twenty-first aspect, the glass body of any one of the first through twentieth aspects, wherein an average Tzc of a plurality of segments of the glass body is in a range from about 20 °C to about 60 °C, the plurality of segments including every adjacent segment across the length and the width of the glass body, the length being about 25 mm or more and the width being about 25 mm or more.

According to a twenty-second aspect, the glass body of any one of the first through twenty-first aspects, wherein the length is about 50 mm or more and the width is about 50 mm or more.

According to a twenty-third aspect, the glass body of any one of the first through twenty-second aspects, wherein the length is about 100 mm or more and the width is about 100 mm or more.

According to a twenty-fourth aspect, a glass body comprising an SiO₂ concentration of about 80 wt. % or more and a TiO₂ concentration of about 6.0 wt. % to about 12.0 wt. %, wherein the glass body comprises a maximum fast Fourier transform amplitude of refractive index variation of about 1.0×10⁻⁶ or less over a spatial frequency range from 30 m⁻¹ to 500 m⁻¹, the glass body comprises a minimum fast Fourier transform amplitude of refractive index variation of about 1.0×10⁻⁹ or greater over a spatial frequency range from 30 m⁻¹ to 500 m⁻¹, the glass body comprises a fast Fourier transform amplitude of refractive index variation of about 2.0×10⁻⁶ or less over a spatial frequency range from 500 m⁻¹ to 3,000 m⁻¹, and the glass body comprises a minimum fast Fourier transform amplitude of refractive index variation of about 0.0×10⁻¹¹ or greater over a spatial frequency range from 500 m⁻¹ to 3,000 m⁻¹.

According to a twenty-fifth aspect, the glass body of the twenty-fourth aspect, wherein a P-V of average refractive index of a plurality of segments of the glass body is about 1×10⁻⁴ or less, the plurality of segments including every adjacent segment across a length and a width of the glass body, the length being about 25 mm or more and the width being about 25 mm or more.

According to a twenty-sixth aspect, the glass body of the twenty-fifth aspect, wherein the P-V of the average refractive index of the plurality of segments of the glass body is about 5×10⁻⁷ or less, the plurality of segments including every adjacent segment across the length and the width of the glass body, the length being about 25 mm or more and the width being about 25 mm or more.

It will be apparent to those skilled in the art that various modifications and variations can be made to embodiments of the present disclosure without departing from the spirit and scope of the disclosure. Thus, it is intended that the present disclosure cover such modifications and variations provided they come within the scope of the appended claims and their equivalents.

What is claimed is:

1. A glass body comprising:
an SiO₂ concentration of about 80 wt. % or more; and
a TiO₂ concentration of about 6.0 wt. % to about 12.0 wt. %,
wherein a fast Fourier transform amplitude spectrum of refractive index variation of the glass body satisfies the following equation over a spatial frequency range from 5 m⁻¹ to 3,000 m⁻¹:
y≤10^{a}·x^{b}
wherein a is equal to about −3.85 or less and b is equal to about −1.0.

2. The glass body of claim 1, wherein a is about −4.00 or less.

3. The glass body of claim 1, wherein a is in a range from about −4.15 to about −3.85.

4. The glass body of claim 1, wherein a P-V of average refractive index of a plurality of segments of the glass body is about 1×10⁻⁴ or less, the plurality of segments including every adjacent segment across a length and a width of the glass body, the length being about 25 mm or more and the width being about 25 mm or more.

5. The glass body of claim 4, wherein the P-V of the average refractive index of the plurality of segments of the glass body is about 5×10⁻⁷ or less, the plurality of segments including every adjacent segment across the length and the width of the glass body, the length being about 25 mm or more and the width being about 25 mm or more.

6. The glass body of claim 1, wherein the glass body comprises a maximum fast Fourier transform amplitude of refractive index variation of about 1.0×10⁻⁶ or less over a spatial frequency range from 30 m⁻¹ to 500 m⁻¹.

7. The glass body of claim 1, wherein the glass body comprises a minimum fast Fourier transform amplitude of refractive index variation of about 1.0×10⁻⁹ or greater over a spatial frequency range from 30 m⁻¹ to 500 m⁻¹.

8. The glass body of claim 1, wherein the glass body comprises a maximum fast Fourier transform amplitude of refractive index variation of about 2.0×10⁻⁶ or less over a spatial frequency range from 500 m⁻¹ to 3,000 m⁻¹.

9. The glass body of claim 1, wherein the glass body comprises a minimum fast Fourier transform amplitude of refractive index variation of about 0.0×10⁻¹¹ or greater over a spatial frequency range from 500 m⁻¹ to 3,000 m⁻¹.

10. The glass body of claim 1, wherein a best fit line of the Fourier transform amplitude spectrum of refractive index variation of the glass body over a spatial frequency range from f 30 m⁻¹ to 500 m⁻¹ is represented by the following equation:
y=10^{c}·x^{d}
wherein a is in c range from about −7.85 to about −6.35 and d is in a range from about −0.70 to 0.00.

11. The glass body of claim 10, wherein c is in a range from about −7.80 to about −6.40 and d is in a range from about −0.65 to about −0.05.

12. The glass body of claim 1, wherein a best fit line of the Fourier transform amplitude spectrum of refractive index variation of the glass body over a spatial frequency range from f 500 m⁻¹ to 3,000 m⁻¹ is represented by the following equation:
y=10^{e}·x^{f}
wherein e is in a range from about −3.85 to about −1.65 and f is in a range from −2.0 to about −1.2.

13. The glass body of claim 12, wherein e is in a range from about −3.70 to about −1.80 and f is in a range from about −1.95 to about −1.55.

14. The glass body of claim 1, wherein an average hydroxyl concentration of a plurality of segments of the glass body is about 100 ppm or greater, the plurality of segments including every adjacent segment across the length and the width of the glass body, the length being about 25 mm or more and the width being about 25 mm or more.

15. The glass body of claim 14, wherein the average hydroxyl concentration of the plurality of segments of the glass body is in a range from about 200 ppm to about 1900 ppm.

16. The glass body of claim 1, wherein a P-V of hydroxyl concentration of a plurality of segments of the glass body is about 100 ppm or less, the plurality of segments including every adjacent segment across the length and the width of the glass body, the length being about 25 mm or more and the width being about 25 mm or more.

17. The glass body claim 16, wherein the P-V of hydroxyl concentration of the plurality of segments of the glass body is about 60 ppm or less.

18. The glass body of claim 1, wherein a P-V of titania concentration of a plurality of segments of the glass body is about 0.0040 wt. % or less, the plurality of segments including every adjacent segment across the length and the width of the glass body, the length being about 25 mm or more and the width being about 25 mm or more.

19. The glass body of claim 1, wherein a P-V of Tzc of a plurality of segments of the glass body is about 0.050 °C to about 0.300 °C, the plurality of segments including every adjacent segment across the length and the width of the glass body, the length being about 25 mm or more and the width being about 25 mm or more.

20. A glass body comprising:
an SiO₂ concentration of about 80 wt. % or more; and
a TiO₂ concentration of about 6.0 wt. % to about 12.0 wt. %,
wherein:
the glass body comprises a maximum fast Fourier transform amplitude of refractive index variation of about 1.0×10⁻⁶ or less over a spatial frequency range from 30 m⁻¹ to 500 m⁻¹,
the glass body comprises a minimum fast Fourier transform amplitude of refractive index variation of about 1.0×10⁻⁹ or greater over a spatial frequency range from 30 m⁻¹ to 500 m⁻¹,
the glass body comprises a fast Fourier transform amplitude of refractive index variation of about 2.0×10⁻⁶ or less over a spatial frequency range from 500 m⁻¹ to 3,000 m⁻¹, and
the glass body comprises a minimum fast Fourier transform amplitude of refractive index variation of about 0.0×10⁻¹¹ or greater over a spatial frequency range from 500 m⁻¹ to 3,000 m⁻¹.
